(19) United States
(12) Patent Application Publication
(10) Pub. No.: US 2023/0024944 A1
(43) Pub. Date: Jan. 26, 2023

(54) BILLBOARD SHEETING MATERIALS

(71) Applicant: COOLEY GROUP HOLDINGS, INC., Pawtucket, RI (US)

(72) Inventors: Yulin Hardin, Hopkinton, MA (US); Bryan W. Rose, Wellington, FL (US)

(21) Appl. No.: 17/812,595

(22) Filed: Jul. 14, 2022

Related U.S. Application Data
(60) Provisional application No. 63/221,730, filed on Jul. 14, 2021.

(51) Int. Cl. B32B 27/12; B32B 5/02; B32B 27/30; G09F 13/00; G09F 15/00

(52) U.S. Cl. CPC B32B 27/12; B32B 5/028; B32B 27/304; G09F 13/00; G09F 15/0012; G09F 15/0037; B32B 2307/402; B32B 2307/406; B32B 2307/54; B32B 2307/581; B32B 2307/734; B32B 2307/41; B32B 2590/00; B29C 48/15

(57) ABSTRACT

A composite material for use as a billboard sheeting material includes a scrim coated on only a single side with PVC. The composite weighs about 5 ounces per square yard.

### CROSS-REFERENCE TO RELATED APPLICATION

This application claims priority to U.S. Provisional Patent Application Ser. No. 63/221,730, filed on Jul. 14, 2021 and titled “BILLBOARD SHEETING MATERIALS,” the entire disclosure of which is hereby incorporated herein by reference in its entirety for all purposes.

### FIELD OF THE DISCLOSURE

Aspects relate generally to composite materials and, more specifically, to billboard sheeting materials.

### BACKGROUND

Billboards are structures which generally provide large format, flat surfaces for displaying out-of-home (OOH) advertising or other communication content to passing drivers, pedestrians or onlookers. They are typically positioned in high-traffic areas, such as along highways, on the side of buildings, in railway stations or at airports, convention centers and sporting arenas. Mobile billboards may be associated with trucks or bicycles to reach and capture the attention of target audiences. While digital billboards are gaining popularity, conventional billboard structures include billboard sheeting material mounted on framing attached to a pole. The billboard sheeting material is typically hand-painted or lithograph-, silkscreen- or inkjet-printed to display various creative content. Billboards must be constructed to handle severe weather conditions and the effects of exposure to the elements. The U.S. Highway Beautification Act, along with various state and local laws, governs the amount, spacing and quality of billboards placed along highways.

### SUMMARY

In accordance with one or more aspects, a billboard sheeting material is disclosed. The material may include a scrim of billboard-scale dimensions, the scrim having a first side and a second side. The material may further include a coating applied on the first side of the scrim. In at least some aspects, no coating is applied on the second side of the scrim.

In accordance with one or more aspects, a billboard is disclosed. The billboard may include a pole, a signage frame mounted on the pole, and a billboard sheeting material as disclosed herein attached to the signage frame.

In accordance with one or more aspects, a method of facilitating the manufacture of a billboard is disclosed. The method may involve providing a billboard sheeting material as disclosed herein to a billboard manufacturing operation.

In accordance with one or more embodiments, a method of making a billboard sheeting material is disclosed. The method may involve laminating a coating on only a first side of a scrim having billboard-scale dimensions.

The disclosure contemplates all combinations of any one or more of the foregoing aspects and/or embodiments, as well as combinations with any one or more of the embodiments set forth in the detailed description and examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 presents a schematic of a billboard sheeting material in accordance with one or more embodiments; and

FIG. 2 presents a schematic of a billboard in accordance with one or more embodiments.

The disclosed features and aspects herein are not limited to the details of construction and the arrangement of components set forth in the following description or illustrated in the drawings. One or more aspects of the present disclosure is capable of other embodiments and of being practiced or of being carried out in ways other than in the manner explicitly described herein.

### DETAILED DESCRIPTION

The present disclosure provides composite materials suitable for use as a billboard sheeting material. These billboard sheeting materials are characterized by various properties which meet the requirements for the intended application, including those pertaining to weight, strength and opacity. The disclosed billboard sheeting materials may match or exceed relevant properties of conventional products but with reduced weight. Beneficially, the disclosed billboard sheeting materials may be associated with less waste upon ultimate disposal.

The disclosed billboard sheeting materials may generally have excellent weathering, printability, colorfastness, fungicidal durability, extruder processability, non-flammability and thermal stability. Beneficially, the overall properties may be conducive to forming a full width billboard sheet that is seamless. In some embodiments, billboard sheeting material may be joined via seam formation in order to produce larger-scale products, such as spectaculars.

In accordance with one or more embodiments, a billboard sheeting material may generally be a composite of a scrim and a coating. The scrim may be the base, substrate or reinforcement for the composite and may add dimensional stability. The overall composite should generally be constructed and arranged to facilitate seamless, wide format printing operations, as well as to withstand the demanding weather and exposure associated with billboard applications.

In accordance with one or more embodiments, the scrim may be suitable for the manufacture of printable billboard sheets. The scrim may generally have dimensions consistent with an intended billboard sheeting material. For example, the scrim may be provided as a roll of material to be coated. The coated roll may then be used as a billboard sheeting material to make one or more billboard sheets upon which creative content can be applied for display. In at least some embodiments, a wide format scrim is seamless.

In accordance with one or more embodiments, the scrim may generally have billboard-scale dimensions. In some non-limiting embodiments, a roll of billboard sheeting material may be about 50 to about 250 feet in width. For example, a roll of billboard sheeting material may be about 62 feet to about 169 feet in width, e.g. 150 feet in width. In another example, a roll of billboard sheeting material may be about 205 feet in width. In some non-limiting embodiments, a roll of billboard sheeting material may be about 50 to about 4,000 linear yards in length. The scrim may generally be consistent with these dimensions.

In some embodiments, the scrim may be a mesh fabric. The scrim may be formed from yarns selected from the group consisting of: polyesters, nylons, polypropylenes, polyamides, polyimides, polylactic acid (PLA), polyethylenes, cellulosic materials, poly acrylics, polycarbonates, polyacetals and ketals, polyurethanes, copolymers and terpolymers, and blends thereof. In some embodiments, the scrim may be made of a (7 to 24) by (7 to 24) count of 50 to 2000 denier threads. In some non-limiting embodiments, a preferred scrim may have a (9)×(9) count of 420-500 denier threads. The scrim may be selected to have a desired weight so as to influence the overall composite weight. In some embodiments, the scrim may weigh less than 2 ounces per square yard. In at least some embodiments, the scrim may weigh less than 1.5 ounces per square yard. The scrim may be of various colors as described further herein.

In accordance with one or more embodiments, the scrim may have a first side and a second side. A coating may be applied to the first side of the scrim. In accordance with various embodiments, no coating may be applied to the second side of the scrim. Without wishing to be bound to any particular theory, applying only a single coating to the scrim may reduce overall weight of the composite material without adversely affecting other material properties.

The coating material may provide a surface having various desired characteristics for billboard applications including smoothness, flexibility, durability and printability. In some embodiments, the coating may generally be made of at least one of thermoplastic polyurethane (TPU), polylactic acid (PLA), synthetic rubbers (CSM) such as chlorosulfonated polyethylene (CSPE), reactive polyurethane (PUR), ethylene-vinyl acetate (EVA), polyethylene terephthalate (PET), polyvinyl chloride (PVC), polyethylene (PE), polypropylene (PP), thermoplastic olefin (TPO), or another material. In at least some non-limiting embodiments, the coating includes PVC. In some non-limiting embodiments, the coating may be a PVC coating as described in U.S. Pat. No. 6,822,024 to Cooley, Inc. (Pawtucket, R.I.) which is hereby incorporated herein by reference in its entirety for all purposes.

The coating may be applied in any desired thickness for the intended end-use and to facilitate printing operations. Coating thickness may impact elasticity, physical strength or other properties of the composite. In some non-limiting embodiments, the coating may be about 2 to about 15 ounces per square yard. For example, the coating may be between 3.5 to 3.75 ounces per square yard. In other examples, the coating may be about 12 ounces per square yard.

In accordance with one or more embodiments, the coating may include one or more additives. It may be desirable to add weather-resistant additives to protect against ultraviolet (UV) radiation, precipitation and/or frost. Heat stabilizers and/or flame retardants may be added. Adhesion promotors, processing aids, fillers, anti-smudge agents, and/or drying agents may facilitate scrim coating as well as downstream printing. Adsorption promotors may facilitate printing impression. Strength and/or elasticity agents may also be added, as well as pigment and/or colorants or additives to increase opacity. In some non-limiting embodiments, the coating may be white. One or more of the additives can be mixed into the coating, applied concurrently, or applied consecutively.

The coating may be formulated to impart a glossy or matt finish depending on desired appearance. Additionally, finishing rolls that are used in the production process of the coated fabrics may be smooth or embossed to provide a glossy or matt finish. In accordance with one or more embodiments, the billboard sheeting material may be constructed and arranged for compatibility with frontlit, backlit or blackout operation.

As mentioned above, the scrim may be of various colors depending on an intended application. In some embodiments, the scrim may be white or unpigmented. In other embodiments, the scrim may be black or otherwise dark. Without wishing to be bound by any particular theory, a dark scrim may mitigate against shine-through which might otherwise conventionally be addressed by applying a dark coating on the second side of the scrim. Using a black scrim may beneficially reduce shine-through without applying a coating on the second side of the scrim to reduce overall composite weight. Dark scrim may, however, be cost prohibitive and so white or other colored scrim may be used in various disclosed embodiments.

In accordance with one or more embodiments, the coating may be applied to the scrim in accordance with various known techniques familiar to those of ordinary skill in the relevant art. In some embodiments, the scrim may be knife coated. In other embodiments, the coating may be applied to the scrim via lamination. The coating may be extruded as a thin film and then laminated in a single-pass operation. The composite may be annealed to alleviate stress or strain. The finished composite may be rolled for easy transportation, handling and installation.

In accordance with one or more specific embodiments, PVC or other material may be extrusion coated onto the scrim. In a non-limiting example, the extruder may use a 200 mm with a 30:1 to 35:1 L/D (length to diameter ratio) barrel, e.g. a 200 mm with a 33:1 L/D barrel. The PVC film is coated on the scrim at temperatures from about 370 to about 400° F. The PVC film and scrim are nip squeezed between a rubber roll and steel roll to promote adhesion of the PVC film to the scrim. The scrim is preheated to a temperature of 100-250° F. prior to coating with PVC film. The PVC film is extruded from the die onto the scrim at the nip point of a steel roll and a rubber roll. The PVC film is on the steel roll side. The nip forces the PVC film against the scrim on one side, and the steel roll cools and smooths the PVC film. The process for making billboard sheeting is a single-stage pass.

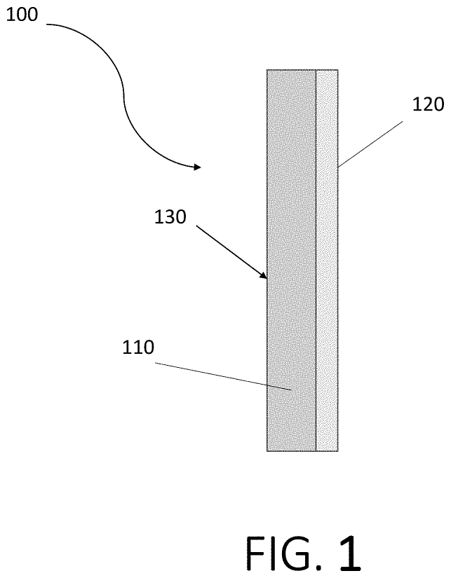

In accordance with one or more embodiments, the overall composite 100 may have a construction that is a sheet including coating 120 on a first side of scrim 110 as illustrated in FIG. 1. Notably, second side 130 of scrim 110 is uncoated.

In accordance with one or more embodiments, the composite may be characterized by a butterfly tear strength of at least about 30 lbs, e.g. about 35 or 40 lbs, in the fill direction and at least about 40 lbs, e.g. about 45 or 50 lbs, in the warp direction.

In accordance with one or more embodiments, the composite may be characterized by a hydrostatic resistance of at least about 170 psi. In some embodiments, the composite may be characterized by a hydrostatic resistance of at least about 180 psi. In at least some embodiments, the composite may be characterized by a hydrostatic resistance of at least about 190 psi.

In accordance with one or more embodiments, the thickness and/or porosity of the scrim and/or coating may contribute to the overall weight and opacity of the composite. In some embodiments, the composite may weigh less than about 7 ounce per square yard. In at least some embodiments, the composite may weigh less than about 6 ounces per square yard. In some specific non-limiting embodiments, the composite may weigh about 5 ounces per square yard, e.g. 5.5 ounces per square yard. In some embodiments, the composite may be characterized by an opacity of at least about 80% which may be desirable in various billboard applications. In some embodiments, the composite may be characterized by an opacity of at least about 85%. In at least some embodiments, the composite may be characterized by an opacity of at least about 90%.

In accordance with one or more embodiments, the disclosed composite materials may be provided for use as a billboard sheeting material.

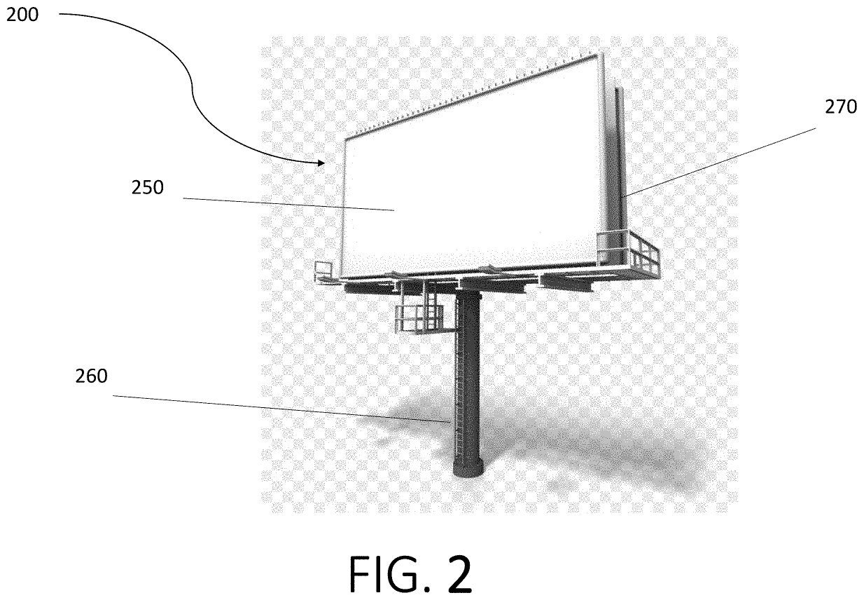

In accordance with one or more embodiments, a billboard 200 may generally involve a large steel-framed sign 270 mounted on a pole 260 as illustrated in FIG. 2. Non-limiting, standard sizes for the steel frame assembly may be 20×60 ft, 20×48 ft, 10×36 ft, 12×25 ft or 6×12 ft. The pole may be between 36 and 72 inches in diameter and up to 100 feet tall. A billboard sheeting material 250 as disclosed herein may be affixed to a face of the sign 270. The billboard sheeting material may include various creative content. In some embodiments, the billboard sheeting material may include a promotion for out of home (OOH) advertising or other communication messaging.

In accordance with one or more embodiments, the thickness and/or porosity of the scrim and/or coating may contribute to the overall weight of a billboard sheeting material 250. In some embodiments, a 20×60 ft billboard sheeting material may weigh less than about 65 pounds. In at least some embodiments, the billboard sheeting material may weigh less than about 60 pounds. In some specific non-limiting embodiments, the billboard sheeting material may weigh about 53 pounds.

In accordance with one or more embodiments, creative content may be printed on the billboard sheeting material, i.e. inkjet printed. In other embodiments, creative content may be applied as an over-graphic, such as via an overlaminate. In still other embodiments, creative content may be hand-painted directly on the billboard sheeting material. Other techniques will be readily apparent to those of skill in the art and the composite billboard sheeting material should generally be constructed and arranged to facilitate display of creative content thereon.

In accordance with one or more embodiments, a billboard may be static. In some embodiments, the billboard may be free-standing. In other embodiments, the billboard may be attached to a structure, such as to the side of a building. The billboard may be one-sided, two-sided or multi-sided. In some non-limiting embodiments, a mechanical billboard may facilitate rotating through two or more billboard sheets via a conveyor system. In accordance with one or more further embodiments, a billboard may be mobile such as may be attached to a truck or bicycle.

In accordance with one or more embodiments, a billboard may be augmented with a telecommunications antenna, a public utility or a public lighting feature.

The function and advantages of these and other embodiments can be better understood from the following examples. These examples are intended to be illustrative in nature and are not considered to be limiting the scope of the invention.

### EXAMPLES

Billboard sheeting materials according to the present disclosure were produced by coating scrim on a single side. Various properties of the billboard sheeting materials were then tested and compared to conventional materials.

Exemplary embodiments of billboard sheeting materials were formed from white scrim and black scrim. The white scrim was made of 420 denier polyester terephthalate (PET) polyester yarn and the count of the scrim was 9×9 (9 yarns in the warp direction, and 9 yarns in the fill direction). The weight of the white scrim was 1.33 oz per sq. yd. The black scrim was made of 500 denier PET polyester yarn with black pigment(s) and the count of the scrim was 9×9 (9 yarns in the warp direction and 9 yarns in the fill direction). The weight of the black scrim was 1.53 oz per sq yd.

Both the white and the black scrims were coated with a PVC compound. The PVC compound contained PVC resin, plasticizer(s), fillers, pigment(s), heat stabilizers and/or UV stabilizers.

In the exemplary billboard sheeting materials, the weight of the PVC layer was about 3.75 oz per sq. yd and the total weight of the billboard sheeting materials (including the PVC film and the scrim) was about 5 oz per sq. yd.

Production Process

To produce the billboard sheeting materials, the scrim was fed through an extrusion machine with or without preheat of the extrusion machine. The scrim was either white scrim or black scrim. The PVC compound was extruded through an extruder and the extruded PVC in a melting state was deposited on the scrim to form a PVC thin film on the scrim. The die width ranged from 12.7 centimeters to 500 centimeters (5 meters).

The temperature setting of the extruder was as follows in Table 1.

TABLE 1
Temperature Settings of the Extruder.

| | |
|---|---|
| Section 1 | 350 F |
| Section 2 | 360F |
| Section 3 | 370F |
| Section 4 | 380F |
| Oie | 380F |

The deposited PVC thin film on the scrim was cooled with a chilling roll and at the same time the scrim and the PVC thin film layer together were fed through a pair of rollers to apply pressure on the scrim and the PVC thin film layer to increase the adhesion between the scrim and the PVC thin film. The billboard substrate was then rolled up and ready for converting.

Testing Equipment

Various properties of exemplary embodiments of the billboard sheeting materials were tested. Physical properties were tested with a Benz Tensile Tester Model TT2102 from Benz Materials Testing Instruments of Providence, R.I., USA. Color was measured with a CM-600d Spectrophotometer from Konica Minolta Sensing Americas, Inc of Ramsey, N.J., USA. Gloss was measured with a micro-tri-gloss gloss meter from BYK Instruments of Wesel, Germany. Opacity was measured with a TD 932 MacBeth Densitometer from Kollmorgen Instruments Corporation of Radford, Va., USA. Printing test was carried out on an HP Latex Printer and HP UV printer from Hewlett-Packard of Palo Alto, Calif., USA.

Measured Properties

The physical properties of the 5 oz PVC billboard sheeting materials of the present disclosure were compared with a known 7 oz PVC billboard sheeting material. The known 7 oz billboard sheeting material and the 5 oz billboard sheeting material with the white scrim disclosed herein were made with the same 1.33 oz per sq yd scrim and exhibited very similar physical properties. The billboard substrate with the black scrim had a higher measured opacity than the 5 oz billboard substrate with the white scrim, as shown in the opacity data presented below in Table 3.

The tested 5 oz PVC billboard substrates of the present disclosure (both white and black scrim) exhibited properties that are suitable for use in providing durable, readable billboards. Table 2 compares the exemplary embodiments of the present disclosure with the known 7 oz billboard material. The tested 5 oz PVC billboard substrates of the present disclosure had a weight in the range of 5.0 oz/sqyd to 5.4 oz/sqyd. The tested 5 oz PVC billboard substrates of the present disclosure had a butterfly tear strength in the range of 50 lbs to 53 lbs in the warp direction which was surprisingly higher than the butterfly tear strength of the 7 oz PVC billboard material in the warp direction. The tested 5 oz PVC billboard substrates of the present disclosure had a butterfly tear strength in the range of 33 lbs to 35 lbs in the fill direction which was generally commensurate with the butterfly tear strength of the 7 oz PVC billboard material in the fill direction. The tested 5 oz PVC billboard substrates of the present disclosure had a hydrostatic resistance in the range of 172 psi to 199 psi. The tested 5 oz PVC billboard substrates of the present disclosure had an opacity in the range of 81.4% to 88.1%.

TABLE 2
Properties of Evaluated Billboard Sheeting Materials

| Property | Unit | Orientation | 7 oz PVC | 5 oz PVC BB White | 5 oz PVC BB |
|---|---|---|---|---|---|
| Weight | oz/sq yd | — | Billboard | scrim | Black scrim |
| | | | 7.3 | 5.0 | 5.4 |
| Butterfly Tear | lbs | warp | 41 | 53 | 50 |
| Strength | | fill | 35 | 35 | 33 |
| 1″ Tensile Strength | lbs | warp | 66 | 70 | 66 |
| | | fill | 59 | 64 | 53 |
| 1″ Tensile Elongation | % | warp | 20.6 | 19.1 | 17.2 |
| | | fill | 22.5 | 20.2 | 19.4 |
| Cold Crack (-30F) | Pass/Fail | warp, face | Pass (5 of 5) | Pass (5 of 5) | Pass (5 of 5) |
| | (# passing | fill, face | Pass (5 of 5) | Pass (5 of 5) | Pass (5 of 5) |
| | of | warp, back | Pass (5 of 5) | — | — |
| | samples | fill, back | Pass (5 of 5) | — | — |
| | tested) | | | | |
| Ball Puncture | lbs | — | 125 | 131 | 115 |
| L* | SCI/SCE | face | 91.44/90.45 | 93.74/92.92 | 91.66/90.66 |
| a* | SCI/SCE | face | 1.46/−1.47 | −0.94/−0.94 | −1.37/−1.39 |
| b* | SCI/SCE | face | −2.24/−2.19 | 0.20/0.28 | −2.06/−2.00 |
| dE* | SCI/SCE | face | N/A | 3.40/3.54 | 0.30/0.29 |
| Whiteness index | SCI/SCE | face | 89.91/87.56 | 83.68/81.42 | 89.53/87.15 |
| Gloss | — | 60 deg | 25 | 16 | 18 |
| Hydrostatic | psi | — | 180 | 199 | 172 |
| Resistance | | | | | |
| Shrinkage (212F, 1 hr) | % | warp | 1.8 | 1.9 | 2.2 |
| | | fill | 0.7 | 0.7 | 0.7 |
| Peel Adhesion | lbs/2″ | — | 10 | 8 | 6 |

TABLE 3
Opacity Properties

| Opacity (%) | Avg |
|---|---|
| Cooley 7 oz, black back | 99.99 |
| 5 oz White Scrim | 81.40 |
| 5 oz Black Scrim | 88.10 |
| Competitor Product 13 oz, white | 82.00 |
| back | |
| Competitor Product 7 oz, black back | 99.99 |

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is therefore to be understood that the embodiments described herein are presented by way of example only and that, within the scope of the appended claims and equivalents thereto; the disclosure may be practiced otherwise than as specifically described.

Moreover, it should also be appreciated that the disclosure is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the disclosure as embodied in the claims. Further, acts, elements, and features discussed only in connection with one embodiment are not intended to be excluded from a similar role in other embodiments.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A billboard sheeting material, comprising:
a scrim of billboard-scale dimensions, the scrim having a first side and a second side; and
a coating applied on the first side of the scrim,
wherein no coating is applied on the second side of the scrim.

2. The material of claim 1, wherein the scrim is unpigmented or white.

3. The material of claim 1, wherein the scrim is black.

4. The material of claim 1, wherein the scrim comprises polyester.

5. The material of claim 1, wherein the scrim has a weight of less than 2 ounces per square yard.

6. The material of claim 5, wherein the scrim weighs less than 1.5 ounces per square yard.

7. The material of claim 1, wherein the scrim is made of at least about 420 denier yarn.

8. The material of claim 7, wherein the scrim is made of at least about 500 denier yarn.

9. The material of claim 1, wherein the coating comprises at least one of thermoplastic polyurethane (TPU), polylactide acid (PLA), synthetic rubbers (CSM) such as chlorosulfonated polyethylene (CSPE), reactive polyurethane (PUR), ethylene-vinyl acetate (EVA), polyethylene terephthalate (PET), polyvinyl chloride (PVC), polyethylene (PE), polypropylene (PP), thermoplastic olefin (TPO), or another material.

10. The material of claim 9, wherein the coating comprises white PVC.

11. The material of claim 1, wherein the coating includes an additive selected from the group consisting of: a processing aid, an adhesion aid, a filler, a heat stabilizer, a UV stabilizer, an anti-frost agent, an antimicrobial agent, a flame retardant, a pigment or a colorant.

12. The material of claim 1, characterized by a butterfly tear strength of at least about 30 lbs in the fill direction, and at least about 45 lbs in the warp direction.

13. The material of claim 1, characterized by an opacity of at least about 85%.

14. The material of claim 1, wherein the composite weighs less than 7 ounce per square yard.

15. The material of claim 14, wherein the composite weighs less than 6 ounces per square yard.

16. The material of claim 15, wherein the composite weighs about 5 ounces per square yard.

17. The material of claim 1, further comprising creative content printed on the coating.

18. A billboard sheeting material having dimensions of about 20 ft by about 60 ft, and an overall weight of less than about 65 pounds.

19. The material of claim 18, wherein the overall weight is less than about 60 pounds.

20. The material of claim 19, wherein the overall weight is less than about 53 pounds.

21. A billboard, comprising:
a pole;
a signage frame mounted on the pole; and
the billboard sheeting material of claim 1 attached to the signage frame.

22. The billboard of claim 21, further comprising creative content printed on the billboard sheeting material.

23. The billboard of claim 21, further comprising an extension or an embellishment.

24. The billboard of claim 21, integrated with a public utility or a public lighting feature.

25. A method of facilitating the manufacture of a billboard, comprising:
providing the billboard sheeting material of claim 1 to a billboard manufacturing operation.

26. A method of making a billboard sheeting material, comprising:
laminating a coating on only a first side of a scrim having billboard-scale dimensions.

27. The method of claim 26, wherein the coating is extruded during lamination in a single-pass operation.

28. The method of claim 26, wherein the scrim comprises polyester.

29. The method of claim 26, wherein the coating comprises PVC.

30. The method of claim 26, further comprising rolling the billboard sheeting material to facilitate downstream processing.
